(19) United States
(12) Patent Application Publication
(10) Pub. No.: US 2010/0073944 A1
(43) Pub. Date: Mar. 25, 2010

(54) LIGHT EMITTING DIODE BULB

(75) Inventor: PIN-CHUN CHEN, TAIPEI CITY (TW)

Correspondence Address: ROSENBERG, KLEIN & LEE, 3458 ELLICOTT CENTER DRIVE-SUITE 101, ELLICOTT CITY, MD, 21043, US

(73) Assignee: EDISON OPTO CORPORATION, TAIPEI HSIEN (TW)

(21) Appl. No.: 12/235,849

(22) Filed: Sep. 23, 2008

(51) Int. Cl. F21V 29/00

(52) U.S. Cl. 362/373

(57) ABSTRACT

A light emitting diode (LED) light bulb comprising a heat dissipation module, a circuit board, at least one LED light source and a light-transmissible packaging shell is disclosed in the present invention. The heat dissipation module comprises a heat dissipation base and a heat convection tube extended from the heat dissipation base. The circuit board is assembled to the heat dissipation module. The LED light source is arranged on the circuit board, and releases heat energy when projecting at least one illumination light beam. The light-transmissible packaging shell is assembled to the heat dissipation module to package the LED light source, and formed with a heat dissipation opening. The heat convection tube is extended to the heat dissipation opening to communicate with external environment, so that a heat convection action is progressed between the heat convection tube and external environment to dissipate heat energy.

### FIELD OF THE INVENTION

The present invention relates to a light emitting diode light bulb, and more particularly to a light emitting diode light bulb comprising a heat convection tube for dissipating heat energy.

### BACKGROUND OF THE INVENTION

Light Emitting Diode (LED) is an electronic element, which can radiate light when applying electric power. The lighting principle of LED is translating electric power to light energy, that is, doping a minute amount of carriers into a conjunction of P-type side and N-type side and continuously combining the minute amount of carriers with a major amount of carriers to form a LED. In order to achieve a higher performance of the LED, the process may need a large amount of pairs of electrons and holes. The space charge layers become narrower when applying a forward biased voltage, and then a major amount of carriers are doped into the P-type side and the N-type side according to Fermi characteristic energy level deviation. Due to that the minute amount of carriers are increased on the P-type side and N-type side, the pairs of electrons and holes located on the P-type side and the N-type side are recombined to release sufficient photons. In the present, the categories of LED generally include GaAs, GaN, and AlInGaP series, etc. Additionally, adding nitrogen atoms to the GaAs, GaN, and AlInGaP series LED also can change the lighting color of these series of LED.

Generally speaking, the power consumption of the LED light bulb is one eighth of the incandescent light bulb, and the life of the LED light bulb is 50 to 100 times of the incandescent light bulb. Since the LED has the advantages of lightweight, less volume, low power consumption, and long working life, etc., more and more governments have planned schedules to replace the conventional incandescent light bulb by the LED light bulb. Under this background, more and more LED light bulbs are introduced to the public.

However, differing from the conventional incandescent light bulb, LED light bulb is driven by a driver integrated circuit (Driver IC), so that it is usually necessary to arrange the driver IC on a circuit board. Moreover, the driver IC and the LED are temperature sensitive components such that the performance and/or functionality may worsen or fail under high temperature, so that it is necessary to assemble a proper heat dissipation module to the circuit board to dissipate heat energy generated when providing illumination, and further to ensure that the driver IC and the LED would not fail under high temperature. Therefore, the existed LED light bulb usually comprises the circuit board and the heat dissipation module as mentioned.

Based on above description, a conventional LED light bulb is disclosed for reference. Please refer to FIG. 1 and FIG. 2, wherein FIG. 1 is a perspective view of a conventional LED light bulb; and FIG. 2 illustrates the inner structure of the conventional LED light bulb and the main heat dissipation paths therein. As shown in the figures, a LED light bulb 1 comprises a bottom base 11, a heat dissipation module 12, a transparent shell 13, a circuit board 14 and a plurality of LED light sources 15.

The heat dissipation module 12 is assembled to the bottom base 11, and comprises a plurality of heat dissipation fins 121. The circuit board 14 is assembled to the heat dissipation module 12, and the LED light sources 15 are arranged on the circuit board 14. The transparent shell 13 is assembled to the heat dissipation module 12 to package the LED light sources 15.

When the LED light sources 15 project at least one illumination light beam ILB0, heat energy is generated. Heat energy is mainly transferred to the heat dissipation fins 121 (shown in FIG. 1) through a heat conduction path CDP0 within the heat dissipation module 12, and then a heat convection action is progressed with external environment through a heat convection path CVP0, so as to dissipate heat energy.

However, in the prior arts, when the LED light sources 15 are operating with higher power, the heat energy would be increased simultaneously. It would be insufficient to dissipate heat energy only through the heat conduction path CDP0 and the heat convection path CVP0 as mentioned. Hence, the inventor is of the opinion that it is necessary to develop a new LED light bulb capable of dissipating heat energy through more heat dissipation paths to improve the efficiency of heat dissipation.

### SUMMARY OF THE INVENTION

In prior arts, the efficiency of heat dissipation of the LED light bulb is insufficient. Therefore, the primary objective of the present invention is to provide a new LED light bulb, in which a heat convection tube is provided to progress a heat convection action with external environment, so as to additionally provide another path for heat dissipation.

Means of the present invention for solving the problems as mentioned above provides a light emitting diode (LED) light bulb. The LED light bulb comprises a heat dissipation module, a circuit board, at least one LED light source and a light-transmissible packaging shell. The heat dissipation module comprises a heat dissipation base and a heat convection tube extended from the heat dissipation base. The circuit board is assembled to the heat dissipation module. The LED light source is arranged on the circuit board, and releases heat energy when projecting at least one illumination light beam. The light-transmissible packaging shell is assembled to the heat dissipation module to package the LED light source, and formed with a heat dissipation opening. The heat convection tube is extended to the heat dissipation opening to communicate with external environment, so that a heat convection action is progressed between the heat convection tube and external environment to dissipate heat energy. Comparing with the conventional LED light bulb as disclosed in prior arts, in the present invention, the heat dissipation module comprises a heat convection tube communicating with external environment, so that a heat convection action can be progressed to provide another heat dissipation path to effectively raise the heat efficiency of heat dissipation, and to further improve the working efficiency and reliability of the LED light bulb.

The devices, characteristics, and the preferred embodiment of this invention are described with relative figures as follows.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a conventional LED light bulb;

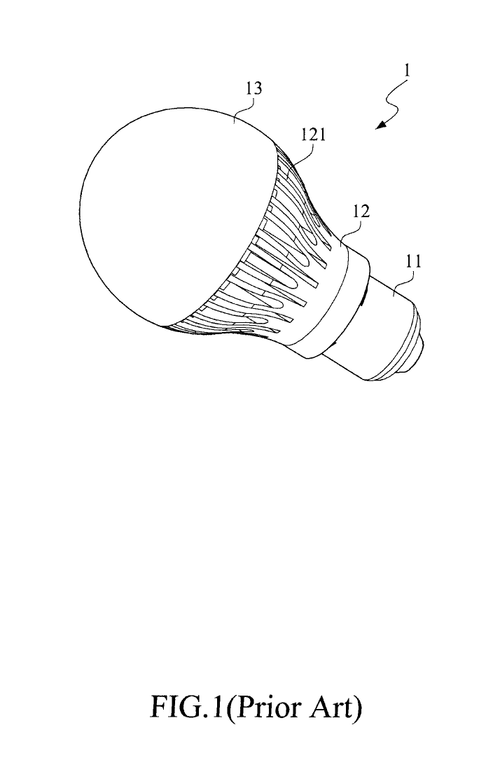

FIG. 2 illustrates the inner structure of the conventional LED light bulb and the main heat dissipation paths therein;

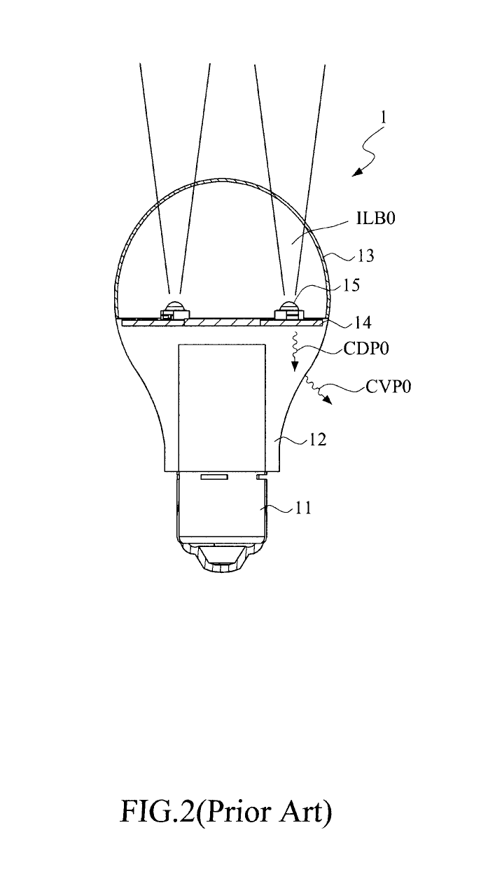

FIG. 3 is a partially exploded view of an LED light bulb in accordance with a preferred embodiment of the present invention;

FIG. 4 is a perspective view of the LED light bulb in accordance with the preferred embodiment of the present invention;

FIG. 5 illustrates the inner structure of the LED light bulb in accordance with the preferred embodiment of the present invention; and

FIG. 6 illustrates that the main heat dissipation paths in accordance with the preferred embodiment of the present invention.

### DETAILED DESCRIPTION OF THE PREFERRED EMBODIMENTS

The LED light bulb as disclosed in the present invention can be widely used to replace the conventional incandescent light bulbs, compact fluorescent lamp and the existed LED light bulbs, and the combined applications of the present invention are too numerous to be enumerated and described. Therefore, only a preferred embodiment is disclosed as follows for representation.

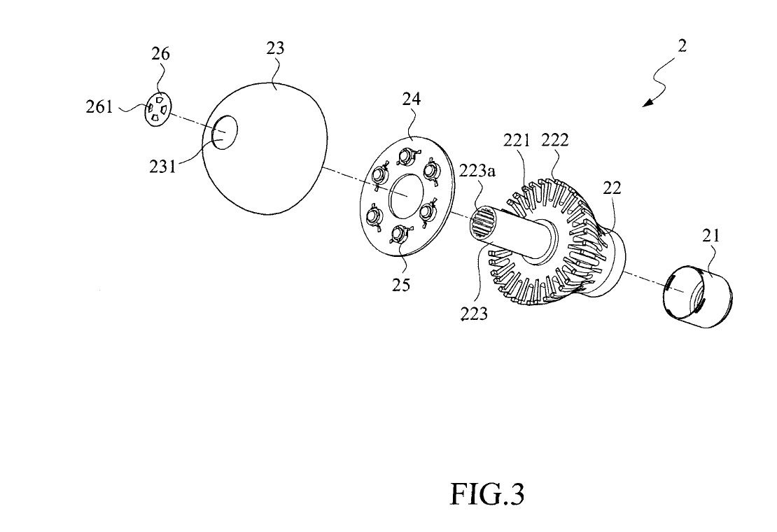

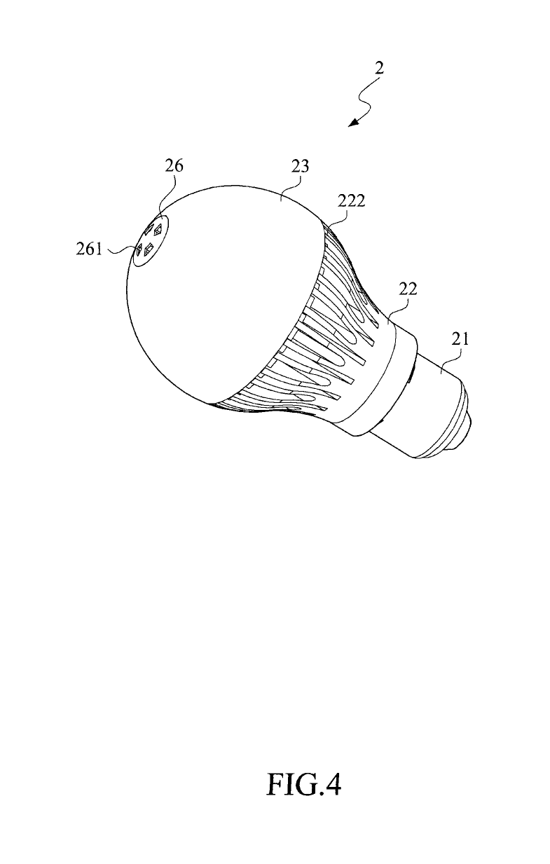

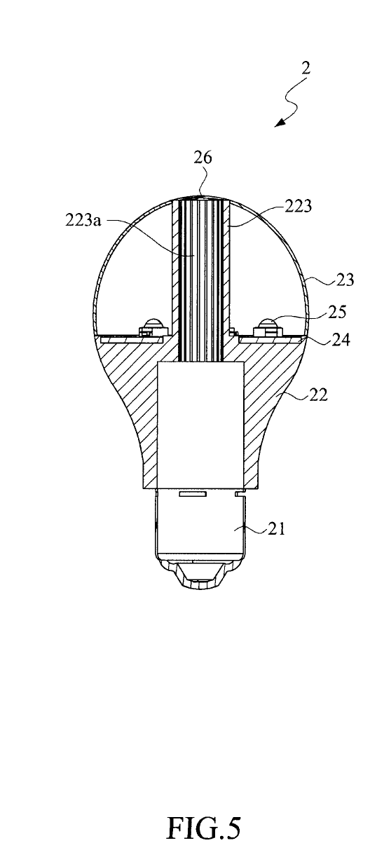

Please refer to FIG. 3 to FIG. 5, wherein FIG. 3 is a partially exploded view of an LED light bulb in accordance with a preferred embodiment of the present invention; FIG. 4 is a perspective view of the LED light bulb in accordance with the preferred embodiment of the present invention; and FIG. 5 illustrates the inner structure of the LED light bulb in accordance with the preferred embodiment of the present invention. As shown in the figures, an LED light bulb 2 comprises a bottom base 21, a heat dissipation module 22, a light-transmissible packaging shell 23, a circuit board 24, a plurality of LED light sources 25 and a tube cap 26.

The heat dissipation module 22 is assembled to the bottom base 21, and comprises a heat dissipation base 221, a plurality of heat dissipation fins 222 and a heat convection tube 223. The heat dissipation fins 222 are outwardly and radially extended from the heat dissipation base 221. The heat convection tube 223 is also extended from the heat dissipation base 221, and has a wavy inner wall 223a. The circuit board 24 is assembled on the heat dissipation module 22, and the LED light sources 25 are arranged on the circuit board 24.

The light-transmissible packaging shell 23 is assembled to the heat dissipation module 22 for packaging the LED light source 25. Besides, the light-transmissible packaging shell 23 is formed with a heat dissipation opening 231. The heat convection tube 223 is extended to the heat dissipation opening 231, and communicates with external environment. The tube cap 26 is formed with at least one opening 261, and assembled to the heat dissipation opening 231. In the preferred embodiment, the heat convection tube 223 is vertical to the circuit board 24.

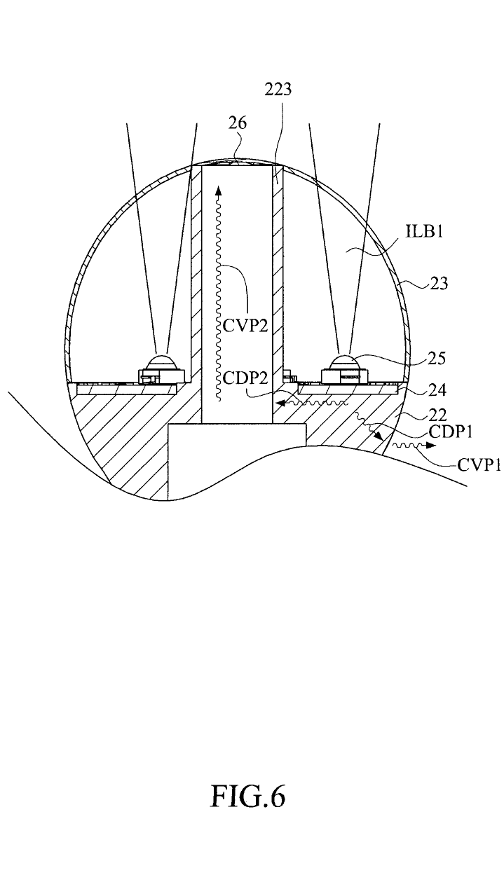

Please refer to FIG. 6, which illustrates that the main heat dissipation paths in accordance with the preferred embodiment of the present invention. As shown in FIG. 6, the LED light sources 25 can project at least one illumination light beam ILB1, which passes through the light-transmissible packaging shell 23 to provide illumination to external environment. When the LED light sources 25 project the illumination light beam ILB1, heat energy is generated. Heat energy is mainly transferred to the heat dissipation fins 222 (shown in FIG. 3) and the heat convection tube 223 via a heat conduction path CDP1 and another heat conduction path CDP2 respectively.

Heat energy transferred to the heat dissipation fins 222 can be dissipated by a heat convection action progressed through a heat convection path CVP1 between the heat dissipation fins 222 and external environment. More importantly, in the preferred embodiment of the present invention, heat energy transferred to the heat convection tube 223 can be simultaneously dissipated by another heat convection action progressed through another heat convection path CVP2 between the heat convection tube 223 and external environment.

After reading the technology as disclosed in above description, it is believable that any person skilled in ordinary art can easily make clear that, comparing with the LED light bulb 1 of the prior arts, in the LED light bulb 2 provided in accordance with the preferred embodiment of the present invention, the heat conduction path CDP2 and the heat convection path CVP2 are provided additionally to dissipate heat energy; therefore, the means as provided in the present invention really can enhance the heat dissipation efficiency. Furthermore, due to that the heat convection tube 223 has the wavy inner wall 223a, it is able to increase the effective contact area for progressing heat exchange with air within the heat convection tube 223, so as to further enhance the heat dissipation efficiency.

Furthermore, in the preferred embodiment of the present invention, the tube cap 26 is assembled to the heat dissipation opening 231 of the light-transmissible packaging shell 23. However, in practical applications, it is allowable to provide the LED light bulb 2 without the tube cap 26. Moreover, the tube cap 26 also can be formed in an integral part with the light-transmissible packaging shell 23.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A light emitting diode (LED) light bulb, comprising:
a heat dissipation module, comprising:
a heat dissipation base; and
a heat convection tube extended from the heat dissipation base;
a circuit board assembled to the heat dissipation module;
at least one LED light source arranged on the circuit board, and releasing a heat energy when projecting at least one illumination light beam; and
a light-transmissible packaging shell assembled to the heat dissipation module, packaging the LED light source for the illumination light beam transmitting through, and formed with a heat dissipation opening;
wherein the heat convection tube is extended to the heat dissipation opening to communicate with external environment, so that a heat convection action is progressed between the heat convection tube and external environment to dissipate the heat energy.

2. The LED light bulb as claimed in claim 1, wherein the heat dissipation module further comprises a plurality of heat dissipation fins outwardly and radially extended from the heat dissipation base.

3. The LED light bulb as claimed in claim 1, wherein the heat convection tube has a wavy inner wall.

4. The LED light bulb as claimed in claim 1, wherein the heat convection tube is vertical to the circuit board.

5. The LED light bulb as claimed in claim 1, further comprising a tube cap assembled to the heat dissipation opening and formed with at least one opening.
